(19) United States
(12) Patent Application Publication
(10) Pub. No.: US 2009/0077551 A1
(43) Pub. Date: Mar. 19, 2009

(54) VIRTUAL MACHINE IMAGE BUILDER FOR AUTOMATED INSTALLATION OF FULLY-VIRTUALIZED OPERATING SYSTEM

(75) Inventor: James Bart WHITELEY, Provo, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 11/856,902

(22) Filed: Sep. 18, 2007

(51) Int. Cl. G06F 9/455

(52) U.S. Cl. 718/1

(57) ABSTRACT

A customized image can be generated from a specified generic image and modifications. The contents of the generic image can be extracted and modified according to the specified modifications. The modifications can include, among other possibilities, a response file used in automating the installation of the customized image. The customized image can then be generated from the modified contents, and then installed as a guest operating system in a fully-virtualized operating system.

### FIELD OF THE INVENTION

This invention pertains to virtualized systems, and more particularly to automated installation of a guest operating system in a fully-virtualized system.

### BACKGROUND OF THE INVENTION

Virtualized systems permit a user to run (potentially) any desired operating system on a computer. If the virtualized system is sufficiently sophisticated, a user can install and run many different operating systems at the same time, and switch between them as desired. The user might even be able to install and run operating systems that normally cannot be installed and run on a single computer at the same time.

There are two basic models for virtualized systems: the fully virtualized system and the para-virtualized system. In the fully virtualized system, the user boots the computer using the host operating system. Once the host operating system is operational, a virtual machine manager (VMM) is activated. The VMM interfaces between the host operating system and the underlying hardware on the one hand, and the guest operating system on the other. Among other functionalities, the VMM emulates the BIOS (Basic Input/Output System) of the computer. The VMM permits the guest operating system to be installed and run as though it were communicating directly with the hardware. In this manner, any desired operating system can be installed as the guest operating system without any special installation requirements. But because the guest operating system thinks it is communicating directly with the hardware, it is not possible to pass parameters to the guest operating system during the boot process. As a consequence, installation of the guest operating system in a fully-virtualized system is a manual process, requiring human involvement.

In contrast, the para-virtualized system permits parameters to be transferred to the guest operating system during the boot process. This capability permits the guest operating system to be installed in a completely automated manner. But this capability comes at a price: the guest operating system must “know” that it is running on a virtualized system. To achieve this capability, the guest operating system needs to be specially designed: an off-the-shelf copy of a standard operating system will not work as a guest operating system in a para-virtualized system.

A need remains for a way to permit installation of a guest operating system on a fully-virtualized system without human involvement that addresses these and other problems associated with the prior art.

### SUMMARY OF THE INVENTION

In an embodiment of the invention, a fully-virtualized system can request installation of a guest operating system. A customized installation of the guest operating system can be generated on-the-fly by extracting contents from a generic image, modifying those contents, and building the customized image.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a system to generate a customized image on-the-fly for installation as a guest operating system, according to an embodiment of the invention.

FIG. 2 shows the modifier of FIG. 1 customizing the contents of the generic image.

FIG. 3 shows a machine on which the customized on-the-fly image of the guest operating system generated by the system of FIG. 1 can be installed.

FIG. 4 shows the machine of FIG. 3 and the system of FIG. 1 connected via a network.

FIG. 5 shows a flowchart of the procedure for generating a customized image on-the-fly in the system of FIG. 1.

FIG. 6 shows a flowchart of the procedure for installing a customized image generated on-the-fly by the system of FIG. 1.

### DETAILED DESCRIPTION OF THE PREFERRED EMBODIMENT

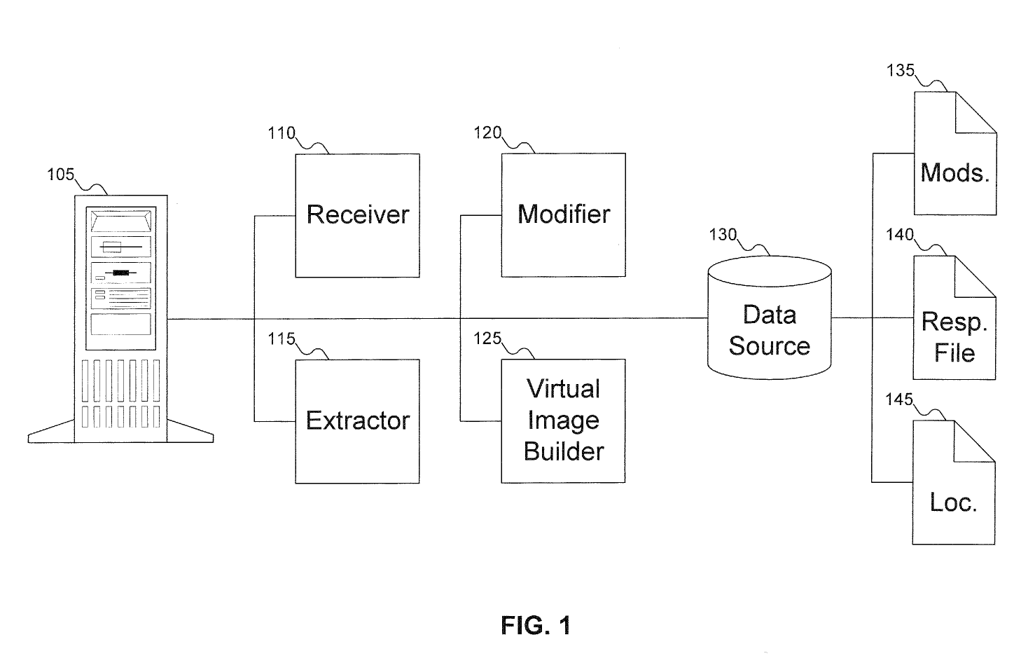

FIG. 1 shows a system to generate a customized image on-the-fly for installation as a guest operating system, according to an embodiment of the invention. In FIG. 1, server 105 is shown. Server 105 includes a number of components used to generate customized images. While server 105 can be a machine dedicated to generating customized images, a person skilled in the art will recognize that server 105 can be any variety of machine, and does not have to be a machine dedicated to a single purpose. Server 105 includes various machine components (not shown in FIG. 1), such as a central processing unit (server 105 can be a single processor or multi-processor system, and each processor can have any number of cores) and storage forms (which can include Random Access Memory (RAM), one or more hard drives, optical storage, and other forms of storage). Further, server 105 can include equipment (not shown in FIG. 1) to support input to and output from server 105, such as a keyboard, a mouse, and a monitor.

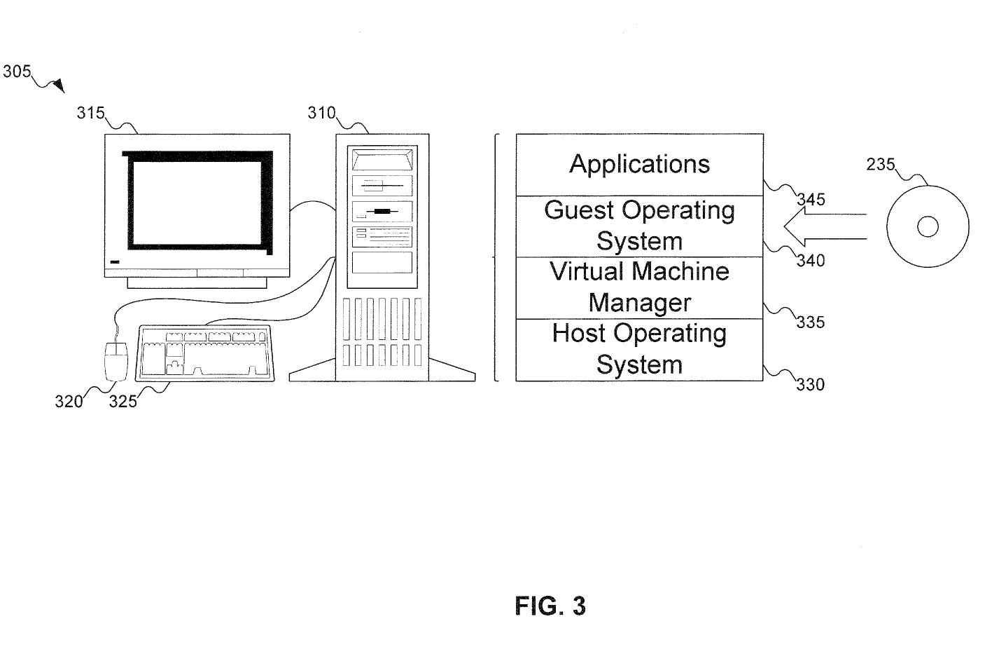

Server 105 includes receiver 110, extractor 115, modifier 120, virtual image builder 125, and data source 130. Receiver 110 is used to receive a request for a customized image to be built on-the-fly. Receiver 110 can receive such a request from a computer system, such as computer system 305 (see FIG. 3 below). Server 105 uses extractor 115 to extract the contents of a generic image. Once extracted, the contents of the generic image can be modified by modifier 120 as needed for the customized image. Modifier 120 can use modifications 135, 140, and 145 stored in data source 130 to perform modifications to some (or all) of the contents extracted from the generic image. Data source 130 can be any desired medium to store modifications 135, 140, and 145: for example, a configuration file, a database, or an LDAP server. Finally, virtual image builder 125 is responsible for building the custom image from the modified contents of the generic image. Virtual image builder 125 can be, for example, an enterprise automation software, used to generate the customized image, that is bootable and can be installed as the guest operating system. Installation of the guest operating system typically involves booting the customized image on the target machine, which runs a host operating system and a virtual machine manager (VMM).

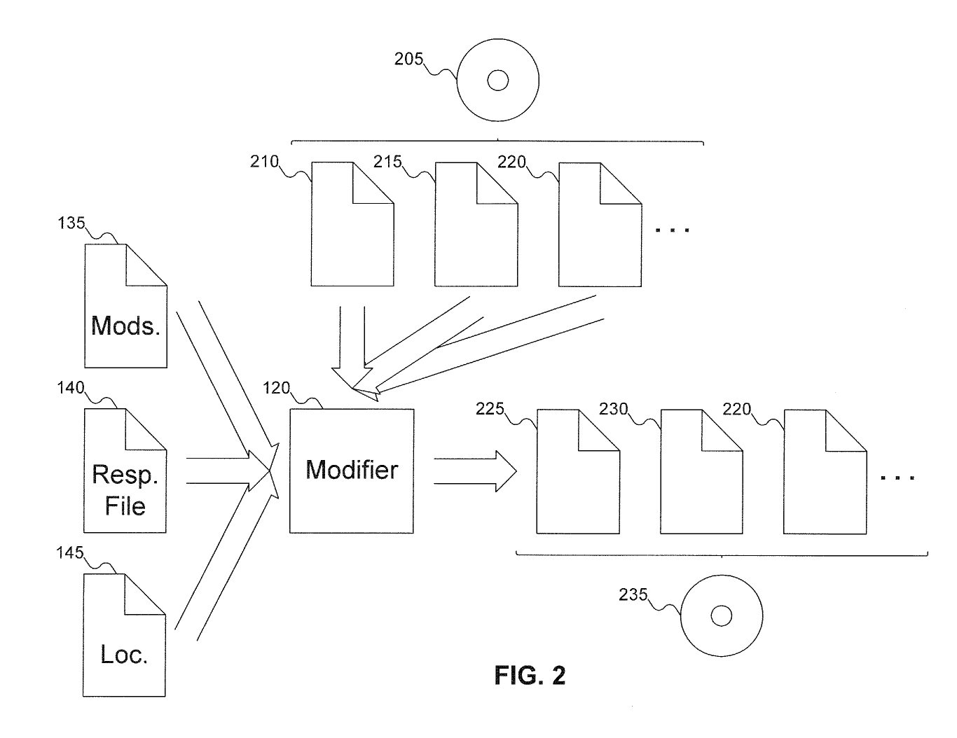

FIG. 2 shows in more detail how the customized image can be generated. In FIG. 2, generic image 205 is a generic image of an operating system. Files 210, 215, and 220 have been extracted from generic image 205. While FIG. 2 shows three files extracted from generic image 205, a person skilled in the art will recognize that there can be any number of files extracted from generic image 205. Further, these files can be of any file type: executable, library, etc.

Modifier 120 uses modifications 135, 140, and 145 to modify files 210, 215, and 220 extracted from generic image 205. Modifier 120 might use modifications 135, 140, and 145 to change the contents of files 210, 215, and 220 in some way. For example, modifications 135 might specify some parameters or settings to be used during installation, such as an IP address to be assigned to the computer on which the customized image is installed. Or modifications 135 might specify the particular components to be installed on the computer.

Modifier 120 might also use modifications 135, 140, and 145 to add new files to the contents. For example, modifier 120 might use response file 140 to add a new file (or perhaps more than one) to the contents extracted from generic image 205. This new file can be used during the installation of the customized image to fully automate the installation, without requiring the user's involvement. Examples of some of the issues that can be bypassed with a response file include acceptance of the license agreement, the install language, which components should be installed, and so on.

Modifier 120 might also use modifications 135, 140, and 145 to control specify information about where the customized image is to be installed from. For example, location 145 can specify a particular location from which the customized image is to be installed (that is, the installation medium). This location might be an image on a transportable medium, such as a CD-ROM, or it might be a network-accessible location, such as a folder on a server. By specifying this information in location 145, modifier 120 can modify the files in the customized image so that the specified location can be used during the installation, without the user having to indicate where the customized image file can be found. This, too, can permit installation to be automated, so that the user does not need to interact with the computer during installation of the customized image.

Once modifier 120 has modified the files extracted from generic image 205 as needed, the modified files can be built into a customized image by virtual image builder 125 (see FIG. 1). In FIG. 2, these modified files are shown as files 225, 230, and 220. Note that file 220 was not modified. As with files 210, 215, and 220, there can be any number of modified files. Further, there might be more or fewer modified files than there were files extracted from generic image 205: some unneeded files might have been deleted, and new files (such as response file 140) added. Virtual image builder 125 can then assemble these files into customized image 235.

Modifications 135, 140, and 145 can be managed using policies of the enterprise. By using policies (not shown in FIGS. 1-2), different sets of modifications can be quickly identified for use in generating the customized images. The policies can define, for example, the type of operating system to be installed as a guest operating system, the version of the operating system, the components to be installed, parameters and settings such as the IP address and the host name to be assigned to the guest operating system, and so on. In this manner, by selecting a single policy from those defined and stored on server 105 (FIG. 1), all of modifications 135, 140, and 145 can be readily and quickly identified, and different policies can be used to define different sets of modifications.

The policies can determine onto which machines particular customized images (that is, specific combinations of modifications to produce a particular guest operating system) can be installed. For example, one policy can define a guest operating system that best supports applications that would be used by a software developer (such as programming languages, lower level operating system access, and test software), whereas another policy can define a guest operating system to support a chief financial officer (who would use a different set of applications running on the guest operating system, and would need access to the company's financial records). The developer can be granted access to the first policy, but not the second; the chief financial officer can be granted access to the second policy, but not the first. For example, based on their role within the company or their login ID. A person skilled in the art will recognize other ways in which users can be granted access to policies, such as based on an association between some identifier of the user and an identifier of the policy.

A person skilled in the art will recognize that specific customized bootable images can be generated in advance: for example, customized images that meet certain policies. In such embodiments, the pre-generated images can be those that are frequently used. Then, when the policy is identified the stored pre-generated image can be loaded. But a person skilled in the art will also recognize how embodiments of the invention can permit generation of the customized image on-the-fly, even when the modifications to be made to the customized images are consistent with policies that are frequently used.

FIG. 3 shows a machine on which the customized on-the-fly image of the guest operating system generated by the system of FIG. 1 can be installed. In FIG. 3, computer system 305 is shown as including computer 310, monitor 315, keyboard 320, and mouse 325. A person skilled in the art will recognize that other components can be included with computer system 305: for example, other input/output devices, such as a printer. In addition, FIG. 3 does not show some of the conventional internal components of computer system 305; for example, a central processing unit, memory, storage, etc. Further, although FIG. 3 shows computer system 305 as a conventional desktop computer, a person skilled in the art will recognize that computer system 305 can be any type of machine or computing device capable of supporting a virtual guest operating system.

In FIG. 3, computer system 305 is shown as having four layers. A person skilled in the art will recognize that FIG. 3 is a simplified view of computer system 305, and that there are other layers to computer system 305 not shown: for example, the physical hardware layer is only indirectly represented.

At the bottom of the stack of layers in computer system 305 is host operating system 330. Host operating system 330 communicates with the hardware to achieve the desired end result. Because the aim is for computer system 305 to support a virtual machine model, host operating system 330 does not have to include all of the functionalities often provided in end-user operating systems: such functionalities can be provided by the guest operating system. But a person skilled in the art will recognize that host operating system 330 can include these additional functionalities, if desired (potentially at the cost of the running speed of computer system 305).

Sitting above host operating system 330 is virtual machine manager (VMM) 335. VMM 335 is responsible for interfacing with the guest operating system and appearing to the guest operating system to be the hardware layer, so that the guest operating system thinks it is directly installed on computer system 305. VMM 335 informs host operating system 330 of the requests made of the hardware by the guest operating system, so that the appropriate hardware results can be determined.

Guest operating system 340 resides above VMM 335. Guest operating system 340 is the operating system that the user uses. As discussed above, guest operating system 340 thinks that it is installed directly on the hardware of computer system 305, and so is not aware that it is running as a virtual machine. Guest operating system 340 can be installed from customized image 235 by accessing customized image 235 and running the installation program. While FIG. 3 shows customized image 235 as a CD-ROM, a person skilled in the art will recognize that customized image 235 can be stored on any type of media that can be used for installation of the customized image. For example, customized image 235 can be stored on a hard drive on a server accessible from computer system 305 via a network (not shown in FIG. 3).

Applications 345 can be run on top of guest operating system 340. Examples of such applications can be word processors, spreadsheets, compilers and programming environments, games, and any other types of applications that are compatible with guest operating system 340.

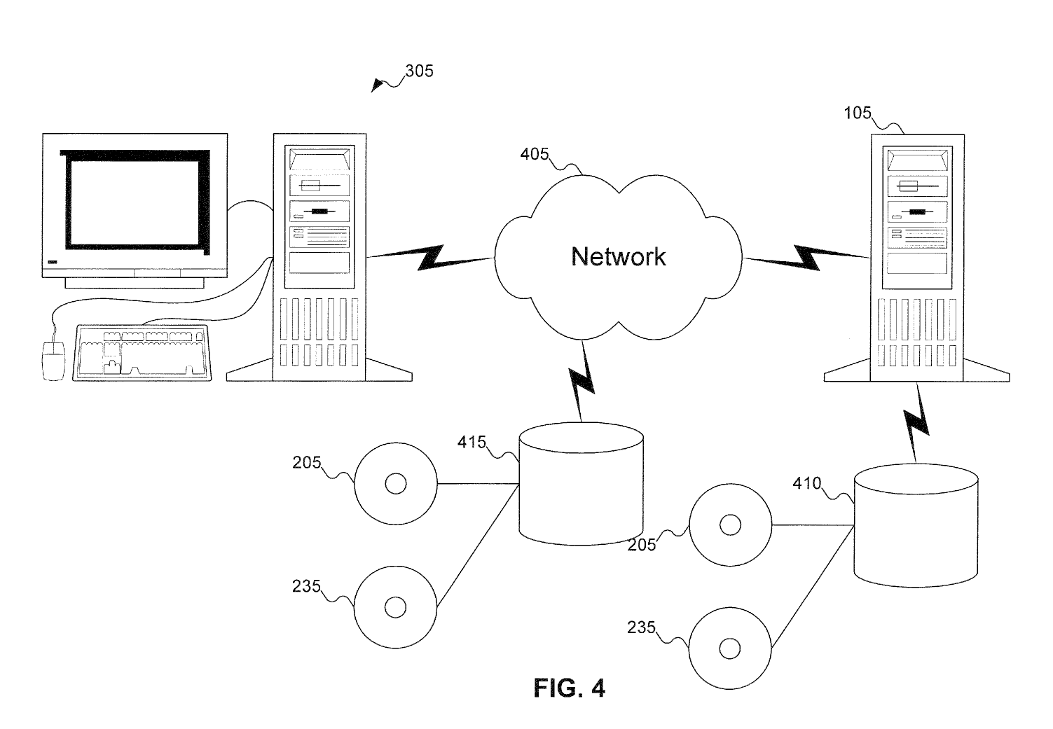

FIG. 4 shows the machine of FIG. 3 and the system of FIG. 1 connected via a network. In FIG. 4, computer system 305 and server 105 are connected via network 405. Network 405 can be any variety of network, and can be a wired network, a wireless network, or a combination of both. For example, network 405 can use any variety of Ethernet connection, any of the IEEE 802.11 a/b/g/n standards for wireless communication, or a Bluetooth network, among other possibilities. Network 405 can include a local area network (LAN), wide area network (WAN), metropolitan area network (MAN), or a global network, such as the Internet.

In FIG. 4, computer system 305 is accessing customized image 235 via network 405 from a remote location. A person skilled in the art will recognize that the term “remote location” does not refer to geography, but rather to the fact that customized image 235 is not available locally on computer system 305.

Computer system 305 can access customized image 235 from server 105. Server 105 can include local storage, such as storage 410, on which customized image 235 can be stored. Storage 410 can be either a volatile or non-volatile storage medium. While FIG. 4 shows customized image 235 and generic image 205 being stored on the same storage 410, a person skilled in the art will recognize that customized image 235 and generic image 205 can be stored on different storage media, and that the different storage media can be of different types. For example, customized image 235 can be stored in a volatile storage medium, such as RAM, whereas generic image 205 can be stored in a non-volatile storage medium, such as a hard drive. In this manner, generic image 205 can be available at any time for production of a customized image, which is only needed until it is installed in the virtual machine (and can then be deleted).

Alternatively, customized image 235 and generic image 205 can be stored on some other storage medium 415 separate from both computer system 305 and server 105. For example, customized image 235 and generic image 205 can be stored on a network attached storage (NAS) device. A person skilled in the art will recognize that customized image 235 and generic image 205 do not need to be stored on the same devices, and can be stored separately. For example, generic image 205 might be stored on storage 415 in a non-volatile medium, whereas customized image 235 can be stored on storage 410 in server 105 in a volatile medium.

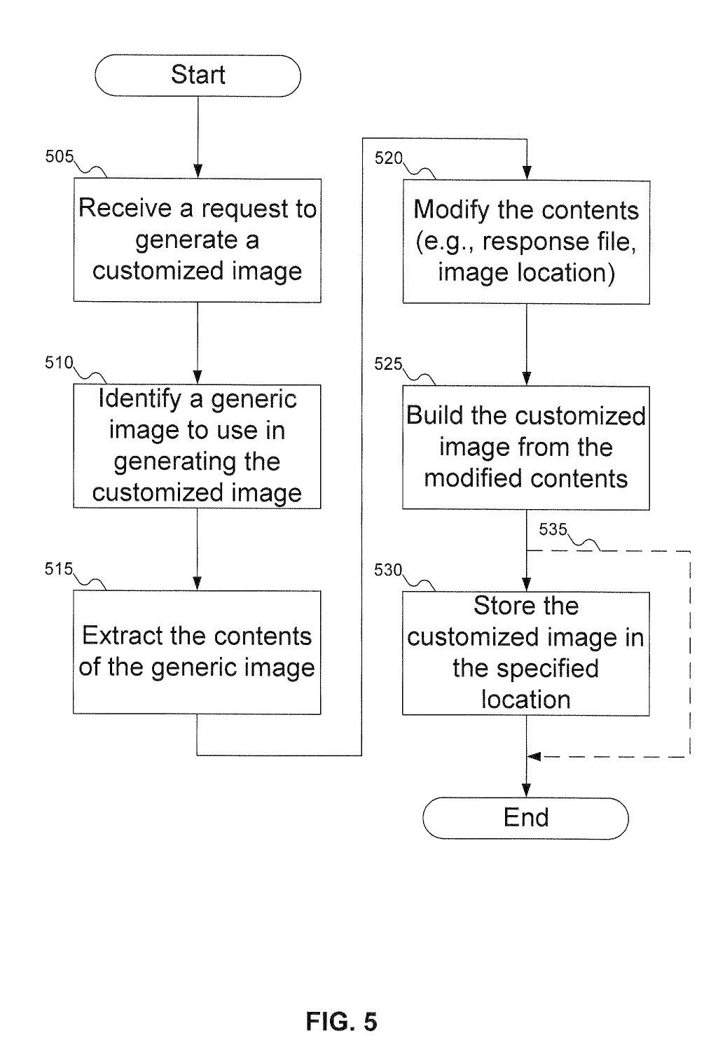

FIG. 5 shows a flowchart of the procedure for generating a customized image on-the-fly in the system of FIG. 1. In FIG. 5, at block 505, the server receives a request to generate a customized image. At block 510, the server identifies a generic image to use as a model in generating the customized image. At block 515, the server extracts the contents of the selected generic image. At block 520, the server modifies the contents to suit the requirements of the customized image. As discussed above, this can involve specifying a response file or a location from which the customized image can be installed, among other possibilities. At block 525, the server builds the customized image based on the modified contents. Finally, at block 530, the server stores the customized image in the specified location. As shown by arrow 535, block 530 can be omitted if desired.

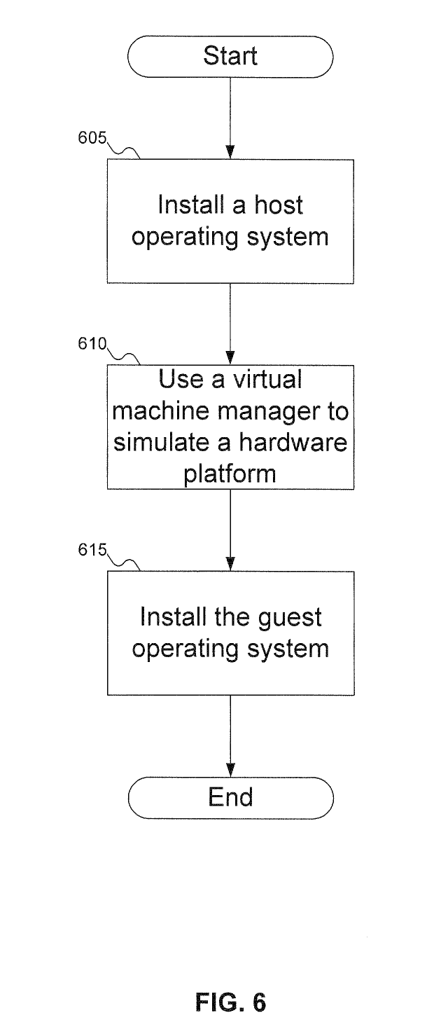

FIG. 6 shows a flowchart of the procedure for installing a customized image generated on-the-fly by the system of FIG. 1. At block 605, a host operating system is installed on the computer system. At block 610, the virtual machine manager (VMM) is used to simulate a hardware platform for the guest operating system, after which the guest operating system can be installed at block 615. After the guest operating system is installed, applications can be installed and run on the virtual machine as desired.

A person skilled in the art will recognize that FIGS. 5 and 6 can be combined in almost any order. For example, in one embodiment FIG. 5 can be implemented before FIG. 6, so that the customized image is generated before the host operating system and VMM are installed. In another embodiment, the host operating system and the VMM can be installed before the customized image of the guest operating system is generated and used. A person skilled in the art will recognize other embodiments that can represent different combinations of FIGS. 5 and 6.

A person skilled in the art will also recognize that there are no timing limitations on the use of embodiments of the invention. For example, in one embodiment a brand new computer system, with no pre-installed host operating system or VMM, can be used. The host operating system, VMM, and guest operating system can all be installed on this new computer system as described above. But in another embodiment an existing computer system already running a host operating system and VMM can be used. A new customized image can be generated so that a new guest operating system can be installed on this existing computer system. In this manner, guest operating systems can be installed as needed by various computer systems on-the-fly.

For example, consider a group of computers, already running host operating systems and VMMs. These computers can be running identical host operating systems and VMMs, or different combinations of host operating systems and VMM, as desired by the administration of the group of computers. Guest operating systems can appear and disappear dynamically on top of these VMMs, as demands and needs change. Some of these guest operating systems might be booted from virtual machine images that already exist. And sometimes it might be desired to install a guest operating system for which a virtual machine image there does not yet exist. In this latter case, a customized image can be generated on-the-fly as described above. Whatever the source for the image of the guest operating system (be it a pre-defined image or a customized image generated on-the-fly), a target computer, with a host operating system and VMM already installed and running can boot this install image, thereby installing the desired guest operating system.

As should be clear from the above description, embodiments of the invention enable the use of a customized image for installation of a guest operating system in a fully-virtualized computer system. The installation can be accomplished without any user involvement depending on the modifications made to the customized image. This avoids the potential delay and complications incurred when the installation of the guest operating system requires the user's involvement, and does not require the guest operating system to be designed with an expectation that the guest operating system knows it is interacting with a virtual machine manager, instead of directly with the hardware.

Embodiments of the invention also avoid difficulties associated with other solutions to the underlying problem. For example, the Preboot Execution Environment (PXE, sometimes termed the Pre-Execution Environment) is a system that permits a computer to boot using a network interface card, independently of any installed storage devices or operating systems. The computer, upon booting, broadcasts a Dynamic Host Control Protocol (DHCP) packet to discover if there is a PXE server. If a PXE server is found, the computer downloads into RAM the operating system to be installed: this download is accomplished using Trivial File Transfer Protocol (TFTP). Then, once downloaded, the computer can install and execute the downloaded operating system.

As can be seen from the above description, to use the PXE protocol requires the PXE infrastructure. The computer must include a network interface card: further, that network interface card must understand the PXE protocol. In addition, there needs to be a PXE server: that is, a server capable of communicating using the PXE protocol. In contrast, embodiments of the invention permit installation of a guest operating system without requiring an understanding of the PXE protocol, or any of the infrastructure. As not all hardware (network interface cards and servers) support the PXE protocol, that embodiments of the invention do not depend on the use of the PXE protocol provides an advantage over the PXE system.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

The invention may be described by reference to or in conjunction with associated data including functions, procedures, data structures, application programs, instructions, etc. which, when accessed by a machine, result in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a receiver (110) to receive a request for a customized image to install as a guest operating system on a fully-virtualized system;
an extractor (115) to extract at least one content file (210, 215, 220) from a generic image file (150);
a data source (130) to store modifications (135, 140, 145) to be made to said at least one content file (210, 215, 220);
a modifier (120) to modify said at least one content file (210, 215, 220) according to said modifications (135, 140, 145) in the data source (130); and
a virtual image builder (125) to build said customized image (235) from said modified at least one content file (225, 230, 240), so that said customized image (235) can be installed as said guest operating system (340) on said fully-virtualized system (305) in a completely automated manner.

2. An apparatus according to claim 1, wherein said modifications (135, 140, 145) include identifying a location (145) from which said customized image (235) can be installed as said guest operating system (340) on said fully-virtualized system (305).

3. An apparatus according to claim 1, wherein said modifications (135, 140, 145) include a response file (140) to be used in automatically responding to prompts during the installation of said customized image (235) as said guest operating system (340) on said fully-virtualized system (305).

4. A method, comprising:
receiving (505) a request to generate a customized image (235) for installation as a guest operating system (340) on a fully-virtualized system (305);
identifying (510) a generic image file (150);
extracting (515) contents (210, 215, 220) from the generic image file (150);
modifying (520) at least one file of the contents (210, 215, 220); and
building (525) the customized image (235) to be installed as the guest operating system (340) on the fully-virtualized system (305) from the modified contents (225, 230, 240).

5. A method according to claim 4, further comprising installing (615) the customized image (235) onto the fully-virtualized system (305).

6. A method according to claim 5, wherein installing (615) the customized image (235) onto the fully-virtualized system (305) includes:
loading (605) a host operating system (330) onto the fully-virtualized system (305);
using (615) a virtual machine manager (335) to simulate a hardware platform for the guest operating system (340); and
installing the customized image (235) on top of the host operating system (330) and the virtual machine manager (335).

7. A method according to claim 4, wherein modifying (520) at least one file of the contents (210, 215, 220) includes identifying a response file (140) to be used when the customized image (235) is to be installed as the guest operating system (340) on the fully-virtualized system (305).

8. A method according to claim 4, wherein modifying (520) at least one file of the contents (210, 215, 220) includes identifying a source location (145) from the customized image (235) can be installed as the guest operating system (340) on the fully-virtualized system (305).

9. A method according to claim 8, wherein building (525) the customized image (235) from the modified contents (225, 230, 240) includes storing (530) the customized image (235) at the source location (145).

10. A method according to claim 9, wherein storing (530) the customized image (235) at the source location (145) includes storing (530) the customized image (235) on a computer-readable medium.

11. A method according to claim 9, wherein storing (530) the customized image (235) at the source location (145) includes storing (530) the customized image (235) on a network-accessible location.

12. An article, comprising a storage medium, said storage medium having stored thereon instructions that, when executed by a machine, result in:
receiving (505) a request to generate a customized image (235) for installation as a guest operating system (340) on a fully-virtualized system (305);
identifying (510) a generic image file (150);
extracting (515) contents (210, 215, 220) from the generic image file (150);
modifying (520) at least one file of the contents (210, 215, 220); and
building (525) the customized image (235) to be installed as the guest operating system (340) on the fully-virtualized system (305) from the modified contents (225, 230, 240).

13. An article according to claim 12, wherein said storage medium has stored thereon further instructions that, when executed by said machine, result in installing (615) the 15 customized image (235) onto the fully-virtualized system (305).

14. An article according to claim 13, wherein installing (615) the customized image (235) onto the fully-virtualized system (305) includes:
loading (605) a host operating system (330) onto the fully-virtualized system (305);
using (615) a virtual machine manager (335) to simulate a hardware platform for the guest operating system (340); and
installing the customized image (235) on top of the host operating system (330) and the virtual machine manager (335).

15. An article according to claim 12, wherein modifying (520) at least one file of the contents (210, 215, 220) includes identifying a response file (140) to be used when the customized image (235) is to be installed as the guest operating system (340) on the fully-virtualized system (305).

16. An article according to claim 12, wherein modifying (520) at least one file of the contents (210, 215, 220) includes identifying a source location (145) from the customized image (235) can be installed as the guest operating system (340) on the fully-virtualized system (305).

17. An article according to claim 16, wherein building (525) the customized image (235) from the modified contents (225, 230, 240) includes storing (530) the customized image (235) at the source location (145).

18. An article according to claim 17, wherein storing (530) the customized image (235) at the source location (145) includes storing (530) the customized image (235) on a computer-readable medium.

19. An article according to claim 17, wherein storing (530) the customized image (235) at the source location (145) includes storing (530) the customized image (235) on a network-accessible location.
